(19) United States
(12) Patent Application Publication
(10) Pub. No.: US 2013/0207475 A1
(43) Pub. Date: Aug. 15, 2013

(54) ENERGY STORAGE SYSTEM AND METHOD FOR COMMUNICATION BASE STATION

(71) Applicant: Huawei Technologies Co., Ltd., (US)

(72) Inventor: Guangyu DONG, Shenzhen (CN)

(73) Assignee: HUAWEI TECHNOLOGIES CO., LTD., Shenzhen (CN)

(21) Appl. No.: 13/625,338

(22) Filed: Sep. 24, 2012

Related U.S. Application Data
(63) Continuation of application No. PCT/CN2012/078858, filed on Jul. 19, 2012.

(30) Foreign Application Priority Data
Feb. 14, 2012 (CN) 201210032676.X

(51) Int. Cl. H02J 1/00

(52) U.S. Cl. 307/80

(57) ABSTRACT

An energy storage system and method for a communication base station and is related to the communications field, to prolong the life cycle of the energy storage system, reduce the operation cost of the communication base station, and increase the rate of return on investment. The energy storage system includes: a first energy storage unit and a switching unit. One switching end of the switching unit has two switching points, which are connected to the first energy storage unit and the second energy storage unit, respectively; and the other switching end of the switching unit is connected to a power supply system of the communication base station and a load of the base station; a monitoring unit, where an output end of the monitoring unit is connected to the control end of the switching unit and configured to input a control signal.

### CROSS-REFERENCE TO RELATED APPLICATIONS

This application is a continuation of International Application No. PCT/CN2012/078858, filed on Jul. 19, 2012, which claims priority to Chinese Patent Application No. 201210032676.X, filed with Chinese Patent Office on Feb. 14, 2012, both of which are hereby incorporated by reference in their entireties.

### FIELD OF THE APPLICATION

The present application relates to the communications field, and in particular to an energy storage system and an energy storage method for a communication base station.

### BACKGROUND OF THE APPLICATION

To ensure reliability of a communication system, a communication base station generally needs its own energy storage system as a backup power source for use in the case of power interruption. When the mains supply or other power supply systems are interrupted, the backup power source supplies power to a load of the communication base station, thereby ensuring normal working of the communication base station.

In the existing communication base station, the energy storage system typically uses lead acid batteries. However, lead acid batteries are not suitable to in-depth charge and discharge, and the communication base station generally requires that the stored electrical energy should last three to five days; therefore, the energy storage system of the communication base station is usually provided with large-capacity lead acid batteries at a high cost. The lead acid batteries of the energy storage system are in the floating charge state after being fully charged. When the mains supply or other power supply systems are interrupted, the lead acid batteries in the floating charge state supply power to the load of the communication base station.

During the implementation of the present application, it is found that the prior art has at least the following problems:

To ensure that power is constantly supplied to the load of the communication base station, and ensure the reliability of the energy storage system, for example, days of the stored electrical energy for use, though the lead acid batteries still have 50% to 80% capacity for use after being used for two to three years, the lead acid batteries need to be replaced with new lead acid batteries. If the lead acid batteries are repeatedly charged and discharged or work under the worst temperature in rough environments, the life cycle of the batteries is even shorter. This results in a short life cycle of the existing energy storage system and a low rate of return on investment.

### SUMMARY OF THE APPLICATION

The present application provides an energy storage system and an energy storage method for a communication base station, to prolong the life cycle of the energy storage system, reduce the operation cost of the communication base station, and increase the rate of return on investment.

In order to achieve the foregoing objectives, the embodiments of the present application adopt the following technical solutions.

An energy storage system for a communication base station includes:

a first energy storage unit, including a plurality of lithium ion batteries;

a second energy storage unit, including a plurality of lead acid batteries;

a switching unit, including: two switching ends and a control end; where the control end is configured to input a control signal for controlling the switching unit to perform switching; one switching end of the switching unit includes two switching points, which are connected to the first energy storage unit and the second energy storage unit, respectively; and the other switching end of the switching unit is connected to a power supply system of the communication base station and a load of the base station;

a monitoring unit, where an output end of the monitoring unit is connected to the control end of the switching unit and configured to input the control signal; the monitoring unit is configured to:

when the power supply system is supplying power, control the switching unit to perform switching, so that the first energy storage unit is connected to the power supply system and the power supply system charges the lithium ion batteries of the first energy storage unit until the lithium ion batteries of the first energy storage unit are fully charged; when the lithium ion batteries of the first energy storage unit are fully charged, control the switching unit to perform switching, so that the second energy storage unit is connected to the power supply system and the power supply system charges the lead acid batteries of the second energy storage unit; when the power supply system is interrupted, control the switching unit to perform switching, so that the first energy storage unit is connected to the load of the base station and the lithium ion batteries of the first energy storage unit supply power to the load of the base station; and when the electrical energy stored in the first energy storage unit is exhausted, control the switching unit to perform switching, so that the second energy storage unit is connected to the load of the base station and the lead acid batteries of the second energy storage unit supply power to the load of the base station.

An embodiment of the present application further provides an energy storage method for a communication base station, including:

monitoring whether a power supply system of the communication base station is interrupted and whether energy storage of a first energy storage unit is in a fully charged state or in an exhausted state, where the first energy storage unit includes a plurality of lithium ion batteries;

when the power supply system is supplying power, connecting the first energy storage unit to the power supply system, so that the power supply system charges the lithium ion batteries of the first energy storage unit until the lithium ion batteries of the first energy storage unit are fully charged;

when the lithium ion batteries of the first energy storage unit are fully charged, connecting a second energy storage unit to the power supply system, where the second energy storage unit includes a plurality of lead acid batteries, and enabling the power supply system to charge the lead acid batteries of the second energy storage unit;

when the power supply system is interrupted, connecting the first energy storage unit to a load of the base station and enabling the lithium ion batteries of the first energy storage unit to supply power to the load of the base station; and

when the electrical energy stored in the first energy storage unit is exhausted, connecting the second energy storage unit to the load of the base station and enabling the lead acid batteries of the second energy storage unit to supply power to the load of the base station.

According to the energy storage system and method provided in the embodiments of the present application, when the power supply system is interrupted, the lithium ion batteries of the first energy storage unit supply power to the communication base station; only when the power supply system is interrupted and the electrical energy stored in the first energy storage unit is exhausted, the power supply is switched to the second energy storage unit, and the lead acid batteries of the second energy storage unit supply power to the communication base station. In this way, the advantages of in-depth charge and discharge and the long life cycle of the lithium ion batteries are fully used. Therefore, the energy storage system and method according to the embodiments of the present application are suitable to various application environments, and may be specifically applied to the environment requiring repeated charge and discharge, for example, frequent power interruption in the power supply system, or the communication base station using solar energy as a power supply system. According to the embodiments of the present application, the lithium ion batteries are in an interrupted and standby state in the case of no power interruption, the lead acid batteries are in a floating charge state; in the case of power interruption, the lithium ion batteries having a long life cycle are firstly used to supply power to the communication base station. Therefore, the lead acid batteries are not frequently used, and the life cycle is prolonged, thereby increasing the maintenance duration of the entire energy storage system, reducing the operation cost of the communication base station, and increasing the rate of return on investment.

### BRIEF DESCRIPTION OF THE DRAWINGS

To illustrate the technical solutions in the embodiments of the present application or in the prior art more clearly, the following briefly describes the accompanying drawings required for describing the embodiments or the prior art. Apparently, the accompanying drawings in the following description merely show some embodiments of the present application, and persons of ordinary skill in the art can derive other drawings from the accompanying drawings without creative efforts.

FIG. 1 is structural block diagram 1 of an energy storage system according to Embodiment 1 of the present application;

FIG. 2 is structural block diagram 2 of an energy storage system according to Embodiment 1 of the present application;

FIG. 3 is a flow chart of an energy storage method according to Embodiment 2 the present application; and

FIG. 4 is a schematic diagram of connection and deployment of an energy storage system according to Embodiment 2 of the present application.

### DESCRIPTION OF THE REFERENCE SIGNS

11—first energy storage unit, 12—second energy storage unit, 13—switching unit, 14—monitoring unit, 141—first monitoring unit, 142—second monitoring unit, 143—control unit, 15—battery management system, 20—power supply system, 21—a load of a communication base station, 22—power system

### DETAILED DESCRIPTION OF THE EMBODIMENTS

The following describes the technical solutions of the embodiments of the present application clearly and completely with reference to the accompanying drawings in the embodiments of the present application. Apparently, the embodiments in the following description are merely a part rather than all of the embodiments of the present application. Other embodiments derived by persons of ordinary skill in the art from the embodiments disclosed herein without creative efforts fall within the protection scope of the present application.

Embodiments of the present application provide an energy storage system and method for a communication base station, to prolong the life cycle of the energy storage system, reduce the operation cost of the communication base station, and increasing the rate of return on investment.

### Embodiment 1

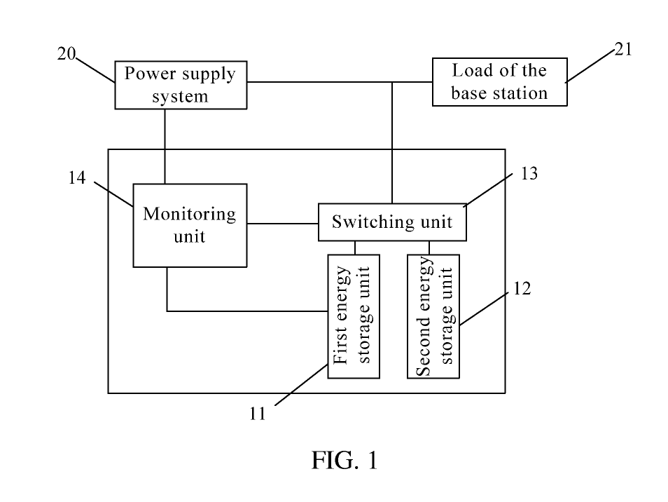

An embodiment of the present application provides an energy storage system for a communication base station. As shown in FIG. 1, the energy storage system includes:

a first energy storage unit 11, including a plurality of lithium ion batteries;

a second energy storage unit 12, including a plurality of lead acid batteries;

a switching unit 13, including: two switching ends and a control end; where the control end is configured to input a control signal for controlling the switching unit 13 to perform switching; one switching end of the switching unit 13 has two switching points, which are connected to the first energy storage unit 11 and the second energy storage unit 12, respectively; and the other switching end of the switching unit 13 is connected to a power supply system 20 of the communication base station and a load 21 of the base station;

a monitoring unit 14, where an output end of the monitoring unit 14 is connected to the control end of the switching unit 13 and configured to input the control signal; the monitoring unit 14 is configured to:

when the power supply system 20 is supplying power, control the switching unit 13 to perform switching, so that the first energy storage unit 11 is connected to the power supply system 20 and the power supply system 20 preferentially charges the lithium ion batteries of the first energy storage unit 11 until the lithium ion batteries of the first energy storage unit 11 are fully charged; when the lithium ion batteries of the first energy storage unit 11 are fully charged, control the switching unit 13 to perform switching, so that the second energy storage unit 12 is connected to the power supply system 20 and the power supply system 20 charges the lead acid batteries of the second energy storage unit 12; when the power supply system 20 is interrupted, control the switching unit 13 to perform switching, so that the first energy storage unit 11 is connected to the load 21 of the base station and the lithium ion batteries of the first energy storage unit 11 supply power to the load 21 of the base station; and when the electrical energy stored in the first energy storage unit 11 is exhausted, control the switching unit 13 to perform switching, so that the second energy storage unit 12 is connected to the load 21 of the base station and the lead acid batteries of the second energy storage unit 12 supply power to the load 21 of the base station.

In this embodiment, the lithium ion batteries of the first energy storage unit 11 are preferentially charged. After the first energy storage unit 11 is fully charged, it is the second energy storage unit 12's turn for charge, and the power supply system 20 charges the second energy storage unit 12 until the second energy storage unit 12 is fully charged. If the power supply system is constantly supplying power, the switching unit 13 constantly maintains the connected state between the second energy storage unit 12 and the power supply system 20. When the monitoring unit 14 monitors that the power supply system 20 is interrupted, the lithium ion batteries of the first energy storage unit 11 are firstly used for external power supply; when the monitoring unit 14 monitors that the electrical energy stored in the first energy storage unit 11 is to be exhausted, the power supply is switched to the second energy storage unit 12, and the lead acid batteries of the second energy storage unit 12 supply power externally.

In this embodiment, the monitoring unit 14 is configured to monitor whether the power supply system 20 is interrupted. One alternative implementation manner is generating, by a relay, a signal (0 or 1) indicating whether the power supply system 20 is supplying power. The monitoring unit 14 is further configured to monitor energy storage of the first energy storage unit 11. During specific implementation, it can be implemented by monitoring the voltage of the lithium ion batteries of the first energy storage unit 11. When the voltage of the lithium ion batteries decreases to a preset voltage, it can be considered that discharge of the first energy storage unit reaches a specified discharge depth, and the electrical energy stored in the lithium ion batteries of the first energy storage unit 11 is to be exhausted.

In this embodiment, one switching end of the switching unit 13 has two switching points, which are connected to the first energy storage unit 11 and the second energy storage unit 12, respectively; and the other switching end of the switching unit is connected to the power supply system 20 of the communication base station and the load 21 of the base station. The switching unit 13 is a controllable single-pole double-throw switch, and controls, according to the control signal input by the control end, the switching points to connect to the first energy storage unit 11 or the second energy storage unit 12.

In this embodiment, the monitoring unit 14 is configured to control, according to the monitored results on whether the power supply system 20 is interrupted and on energy storage of the first energy storage unit 11, the switching unit 13 to perform switching. The monitoring unit 14 may be implemented by a logic control unit having a simple logic programming function.

The functions of the monitoring unit in this embodiment can be readily implemented by any person skilled in the art, and the specific implementation manner is not limited to the above description.

In an existing communication base station, an energy storage system typically uses lead acid batteries. Charge of the lead acid batteries takes a long period of time, and the life cycle of the batteries is short, so the batteries are unsuitable to in-depth charge and discharge. As the lithium ion battery technology becomes mature, lithium ion batteries are gradually replacing the lead acid batteries. However, the lithium ion batteries are expensive. A price estimate in the market shows that, in the case of the same capacity, a lithium ion battery is about six times more expensive than a lead acid battery. If the energy storage system of a communication base station uses the lithium ion batteries, the operation cost of the communication base station is increased by times. In an energy storage system according to an embodiment of the present application, lead acid batteries and lithium ion batteries constitute their respective energy storage units. A monitoring unit controls a switching unit to perform switching between the energy storage unit constituted by the lead acid batteries and the energy storage unit constituted by the lithium ion batteries. In this way, improvement on the performance of the energy storage system, for example, the life cycle and reliability of the energy storage system, is achieved at a relative low cost.

In the energy storage system according to the embodiment of the present application, generally, in the case of temporary power interruption, the lithium ion batteries of the first energy storage unit 11 supply power externally. The lithium ion batteries may be suitable to in-depth charge and discharge, and have a long life cycle, thereby causing little impact on the life cycle of the first energy storage unit 11. Only when the power supply system is interrupted, and the electrical energy stored in the first energy storage unit is exhausted, the power supply is switched to the second energy storage unit 12, and the lead acid batteries supply power to the load of the base station. However, this case seldom occurs. Therefore, the lead acid batteries are not frequently charged and discharged during use, and the life cycle of the lead acid batteries of the second energy storage unit is prolonged. In this way, the life cycle of the entire energy storage system is greatly prolonged, the duration of maintenance may be increased by at least one year, thereby reducing the operation cost of the communication base station and increasing the rate of return on investment.

The energy storage system according to the embodiments of the present application is suitable to various application environments, especially suitable to an area where power interruption frequently occurs or an area where solar energy is used as a power source of the power supply system.

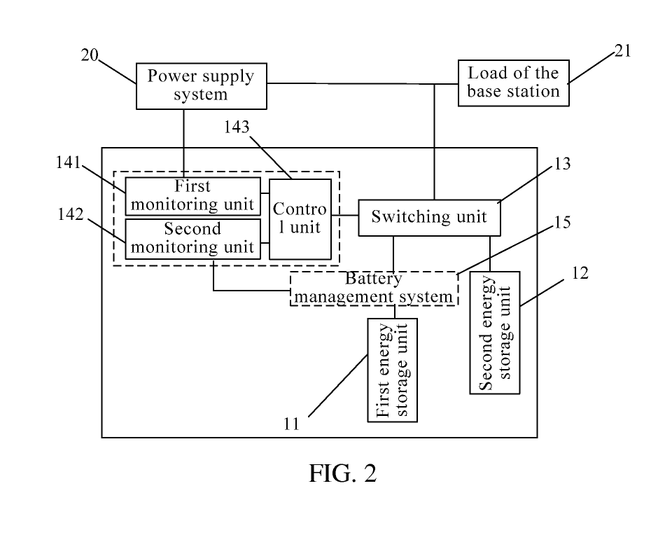

Further, as shown in FIG. 2, the monitoring unit 14 includes:

a first monitoring unit 141, configured to monitor whether the power supply system 20 is interrupted;

a second monitoring unit 142, configured to monitor whether energy storage of the first energy storage unit 11 is in a fully charged state or in an exhausted state; and

a control unit 143, configured to control, according to the monitored results on whether the power supply system 20 is interrupted and on the energy storage of the first energy storage unit 11, the switching unit 13 to perform switching.

In this embodiment, the first monitoring unit 141 may be implemented by generating, a relay, a signal (0 or 1) indicating whether the power supply system 20 is supplying power. The second monitoring unit 142 is configured to monitor energy storage of the first energy storage unit 11. During specific implementation, it can be implemented by monitoring the voltage of the lithium ion batteries of the first energy storage unit 11. The control unit 143 may be implemented by a logic control unit having a simple logic programming function. In this embodiment, supplying power externally by the energy storage system is implemented through the first monitoring unit 141, the second monitoring 142, and the control unit 143. The power supply effect of the energy storage system according to this embodiment may have no difference from an energy storage system constituted by a single type of batteries, but the operation cost is greatly reduced.

The switching unit 13 performs zero-time and non-intermittent switching between the first energy storage unit 11 and the second energy storage unit 12.

When the power supply system is interrupted, the switching unit performs zero-time and non-intermittent switching, so that the first energy storage unit is immediately connected to the load of the base station, and the lithium ion batteries of the first energy storage unit supply power to the load of the base station. When the power supply system is interrupted, and the electrical energy stored in the first energy storage unit that is in the energy storage system and serves as a backup power source is to be exhausted, the switching unit is capable of performing zero-time and non-intermittent switching to switch the power supply to the second energy storage unit, so that the second energy storage unit is connected to the load of the base station, and the second energy storage unit supplies power to the communication base station. A typical switching time is in nanoseconds. During the switching between the first energy storage unit and the second energy storage unit, continuity of the external power supply from the energy storage system can be ensured, and the communication base station will not suspend working due to switching between the energy storage units inside the energy storage system. The power supply effect of the energy storage system according to this embodiment may have no difference from an energy storage system constituted by a single type of batteries, but the operation cost is greatly reduced.

Further, the lead acid batteries may be recycled lead acid batteries.

In an existing communication base station, an energy storage system typically uses large-capacity lead acid batteries, and these lead acid batteries need to be replaced with new ones within two to three years. The old lead acid batteries after replacement still have 50% to 80% capacity for use. If these batteries are subject to disposal, in one aspect, huge waste is caused, and in another aspect, environment pollution is caused. According to the embodiment of the present application, the lead acid batteries of the second energy storage unit of the energy storage system can absolutely use the old lead acid batteries, thereby solving the problem of reuse of the old lead acid batteries of the communication base station, and meanwhile further reducing the cost of the energy storage system. Alternatively, the lead acid batteries may be other recycled lead acid batteries as long as the specifications of these old lead acid batteries satisfy the requirement of the energy storage system of the communication base station.

As shown in FIG. 2, the first energy storage unit further includes: a battery management system (Battery Management System, BMS) 15, configured to prevent over-charge and over-discharge of a lithium ion battery, and increase the utilization rate and the life cycle of the lithium ion battery; where the first energy storage unit 11 is connected to the switching unit 13 and the monitoring unit 14 through the battery management system 15. A lithium ion battery has a long recycle life, and is expensive. To safely use the lithium ion battery and increase the utilization rate and the life cycle of the lithium ion battery, a battery management system is generally needed to manage charge and discharge of the lithium ion battery.

The working status and the energy storage of the lithium ion batteries of the first energy storage unit 11 are reported to the monitoring unit 14 through the battery management system 15. Connection/disconnection between the switching unit 13 and the first energy storage unit 11 is controlled through the battery management system 15.

According to the embodiments of the present application, the energy storage system is suitable to various application environments, and the life cycle and reliability of the energy storage system are greatly improved with a relatively low cost. For example, the maintenance duration of the energy storage system may be increased by one or more years. This reduces the operation cost of the communication base station and improves the rate of return on investment.

### Embodiment 2

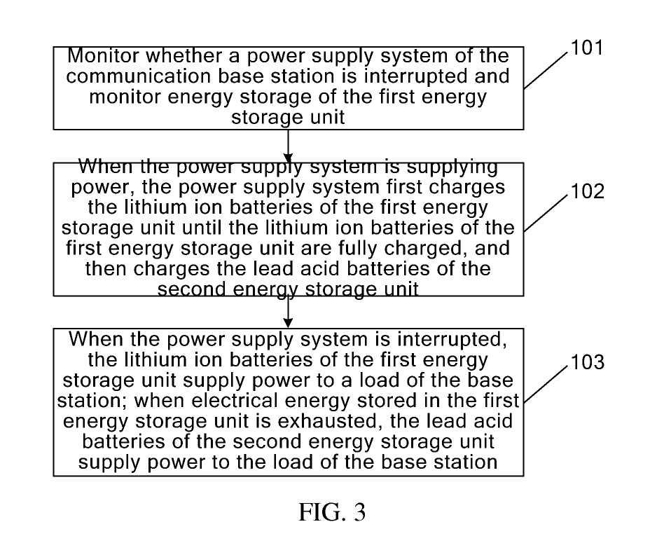

Corresponding to the energy storage system according to Embodiment 1, as shown in FIG. 3, this embodiment further provides an energy storage method for a communication base station, where the method includes:

Step 101: Monitor whether a power supply system of the communication base station is interrupted and whether energy storage of a first energy storage unit is in a fully charged state or in an exhausted state, where the first energy storage unit includes a plurality of lithium ion batteries.

In this step, it is monitored whether the power supply system is supplying power and whether a voltage is normal.

Step 102: When the power supply system is supplying power, connect the first energy storage unit to the power supply system and enable the power supply system to charge the lithium ion batteries of the first energy storage unit until the lithium ion batteries of the first energy storage unit are fully charged; when the lithium ion batteries of the first energy storage unit are fully charged, connect a second energy storage unit to the power supply system, where the second energy storage unit includes a plurality of lead acid batteries, and enable the power supply system to charge the lead acid batteries of the second energy storage unit.

Step 103: When the power supply system is interrupted, connect the first energy storage unit to a load of the base station and enable the lithium ion batteries of the first energy storage unit to supply power to the load of the base station; when the electrical energy stored in the first energy storage unit is exhausted, connect the second energy storage unit to the load of the base station and enable the lead acid batteries of the second energy storage unit to supply power to the load of the base station.

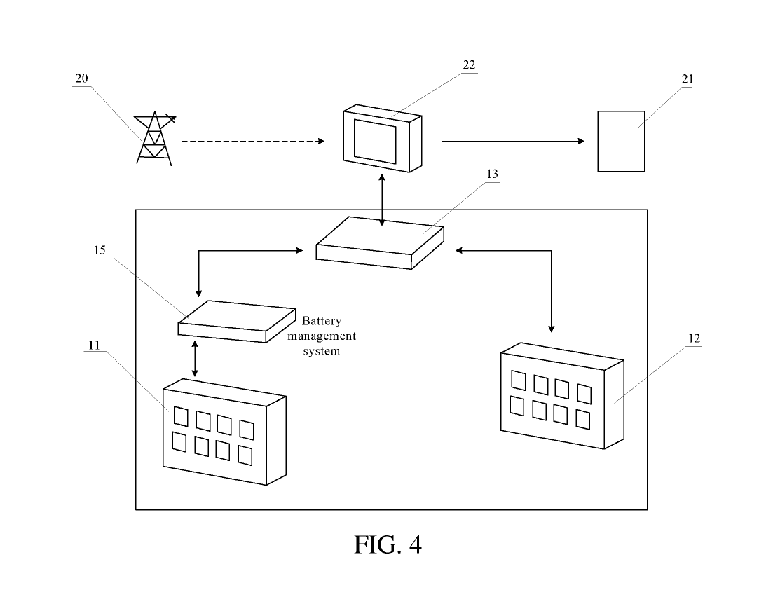

In this embodiment, the power supply system may be a mains supply daily used, or solar energy, or another power supply system. Compared with the prior art, one of advantages of the present application is that the energy storage system and method are more suitable to a solar energy power supply system with frequent charge and discharge, and meanwhile the cost is low. As shown in FIG. 4, a power supply system 20 is a mains supply, the broken line represents an alternating current, and the solid line represents a direct current.

When the power supply system is supplying power, lithium ion batteries of a first energy storage unit 11 and lead acid batteries of a second energy storage unit 12 are charged. When the lithium ion batteries of the first energy storage unit 11 are fully charged, the first energy storage unit 11 is disconnected, and the lead acid batteries of the second energy storage unit 12 are charged. After the second energy storage unit 12 is fully charged, it is still connected to a power supply system 20 through a power system 22 of the communication base station. The lead acid batteries are in a floating charge state until the next time of charge. The lead acid batteries are in the floating charge state for a long period of time, and are not frequently used, and the life cycle of the lead acid batteries is prolonged.

In the energy storage method according to the embodiment of the present application, generally, in the case of temporary power interruption, the lithium ion batteries of the first energy storage unit supply power externally. The lithium ion batteries may be suitable to in-depth charge and discharge, and have a long life cycle, thereby causing little impact on the life cycle of the first energy storage unit. Only when the power supply system is interrupted, and the electrical energy stored in the first energy storage unit is exhausted, the power supply is switched to the second energy storage unit, and the lead acid batteries supply power to the load of the base station. However, this case seldom occurs. Therefore, the lead acid batteries are not frequently charged and discharged during use, and the life cycle of the lead acid batteries of the second energy storage unit is prolonged. In this way, the life cycle of the entire energy storage system is greatly prolonged, the duration of maintenance is increased by at least one year, thereby reducing the operation cost of the communication base station and increasing the rate of return on investment.

The energy storage method according to the embodiment of the present application is suitable to various application environments, especially suitable to an area where power interruption frequently occurs or an area where solar energy is used as the power supply system.

In step 102, when the lithium ion batteries of the first energy storage unit are fully charged, zero-time and non-intermittent switching is performed between the first energy storage unit and the second energy storage unit, so that the second energy storage unit is connected to the power supply system and the power supply system supplies power to the lead acid batteries of the second energy storage unit.

In step 103, when the electrical energy stored in the first energy storage unit is exhausted, zero-time and non-intermittent switching is performed between the first energy storage unit and the second energy storage unit, so that the second energy storage unit is connected to the load of the base station and the lead acid batteries of the second energy storage unit supply power to the load of the base station.

Zero-time and non-intermittent switching performed between the first energy storage unit and the second energy storage unit by a switching unit can ensure that the energy storage system constantly supplies power externally and the communication base station will not suspend working due to power interruption.

Alternatively, when the lithium ion batteries of the first energy storage unit are fully charged, the lead acid batteries are in an interrupted and standby state.

Further, the energy storage method includes:

Step 104: Perform supplementary charge for the lithium ion batteries of the first energy storage unit at regular intervals.

The lithium ion batteries may self-discharge if they are in the interrupted and standby state for a long period of time, and thus the electrical energy contained in the batteries may decrease. Therefore, supplementary charge is performed for the batteries at regular intervals according to practical conditions, to ensure that the electrical energy stored in the first energy storage unit reaches an expected duration of the batteries in terms of days.

Further, the lead acid batteries of the second energy storage unit are recycled lead acid batteries.

Reuse of the old lead acid batteries is environmentally friendly and further reduces the cost of the energy storage system.

With the energy storage method according to the embodiment of the present application, the life cycle of the lead acid batteries and the life cycle of the energy storage system are prolonged, the operation cost of the communication base station is reduced and the rate of return on investment is increased; and meanwhile the problem of reuse of the old batteries of the communication base station is solved.

To improve reliability of a backup power source for the communication base station, the communication base station is generally provided with an oil machine or other power generation devices, to improve reliability of a power source for the communication base station. In the energy storage system and method according to the present application, lithium ion batteries can be provided to serve as the energy storage unit of the backup power source, and the old lead acid batteries are used to replace the oil machine or other power generation devices, to improve the reliability of power supply and reduce the investment cost of the communication base station.

Although the energy storage units in the energy storage system and method according to the embodiments of the present application include only the first energy storage unit and the second energy storage unit, it can be seen that, in practice, the energy storage units in the energy storage system according to the present application should not be limited to two; and correspondingly, the switching points of the switching unit are not limited to two.

Although an embodiment of the present application involves a communication base station, the present application is not limited to the communication base station, and is also applicable to energy storage or power backup of other devices.

The foregoing description is merely exemplary embodiments of the present application, but not intended to limit the protection scope of the present application. Any variation or replacement easily derived by persons skilled in the art within the technical scope disclosed by the present application shall fall within the protection scope of the present application. Therefore, the protection scope of the present application shall be subject to the appended claims.

1. An energy storage system for a communication base station, comprising:
a first energy storage unit, comprising a plurality of lithium ion batteries;
a second energy storage unit, comprising a plurality of lead acid batteries;
a switching unit, comprising: two switching ends and a control end; wherein the control end is configured to input a control signal for controlling the switching unit to perform switching; one switching end of the switching unit comprises two switching points, which are connected to the first energy storage unit and the second energy storage unit, respectively; and the other switching end of the switching unit is connected to a power supply system of the communication base station and a load of the base station; and
a monitoring unit, wherein an output end of the monitoring unit is connected to the control end of the switching unit and configured to input the control signal; the monitoring unit is configured to:
when the power supply system is supplying power, control the switching unit to perform switching, so that the first energy storage unit is connected to the power supply system and the power supply system charges the lithium ion batteries of the first energy storage unit until the lithium ion batteries of the first energy storage unit are fully charged; when the lithium ion batteries of the first energy storage unit are fully charged, control the switching unit to perform switching, so that the second energy storage unit is connected to the power supply system and the power supply system charges the lead acid batteries of the second energy storage unit; when the power supply system is interrupted, control the switching unit to perform switching, so that the first energy storage unit is connected to the load of the base station and the lithium ion batteries of the first energy storage unit supply power to the load of the base station; and when electrical energy stored in the first energy storage unit is exhausted, control the switching unit to perform switching, so that the second energy storage unit is connected to the load of the base station and the lead acid batteries of the second energy storage unit supply power to the load of the base station;
a battery management system, configured to prevent over-charge and over-discharge of the lithium ion batteries, and increase a utilization rate and a life cycle of the lithium ion batteries; wherein the first energy storage unit is connected to the switching unit and the monitoring unit through the battery management system;
wherein the switching unit performs zero-time and non-intermittent switching between the first energy storage unit and the second energy storage unit.

2. The energy storage system according to claim 1, wherein the monitoring unit comprises:
a first monitoring unit, configured to monitor whether the power supply system is interrupted;
a second monitoring unit, configured to monitor whether energy storage of the first energy storage unit is in a fully charged state or in an exhausted state; and
a control unit, configured to control, according to the monitored results on whether the power supply system is interrupted and on the energy storage of the first energy storage unit, the switching unit to perform switching.

3. (canceled)

4. The energy storage system according to claim 1, wherein the lead acid batteries are recycled lead acid batteries.

5. (canceled)

6. An energy storage method for a communication base station, comprising:
monitoring whether a power supply system of the communication base station is interrupted and whether energy storage of a first energy storage unit is in a fully charged state or in an exhausted state, wherein the first energy storage unit comprises a plurality of lithium ion batteries;
when the power supply system is supplying power, connecting the first energy storage unit to the power supply system and enabling the power supply system to charge the lithium ion batteries of the first energy storage unit until the lithium ion batteries of the first energy storage unit are fully charged;
when the lithium ion batteries of the first energy storage unit are fully charged, connecting a second energy storage unit to the power supply system, wherein the second energy storage unit comprises a plurality of lead acid batteries, and enabling the power supply system to charge the lead acid batteries of the second energy storage unit;
when the power supply system is interrupted, connecting the first energy storage unit to a load of the base station and enabling the lithium ion batteries of the first energy storage unit to supply power to the load of the base station; and
when electrical energy stored in the first energy storage unit is exhausted, connecting the second energy storage unit to the load of the base station and enabling the lead acid batteries of the second energy storage unit to supply power to the load of the base station;
wherein when the electrical energy stored in the first energy storage unit is exhausted, the connecting the second energy storage unit to the load of the base station and enabling the lead acid batteries of the second energy storage unit to supply power to the load of the base station comprises:
when the electrical energy stored in the first energy storage unit is exhausted, performing zero-time and non-intermittent switching between the first energy storage unit and the second energy storage unit, so that the second energy storage unit is connected to the load of the base station and the lead acid batteries of the second energy storage unit supply power to the load of the base station;
wherein when the lithium ion batteries of the first energy storage unit are fully charged the connecting the second energy storage unit to the power supply system, comprises:
when the lithium ion batteries of the first energy storage unit are fully charged performing zero-time and non-intermittent switching between the first energy storage unit and the second energy storage unit, so that the second energy storage unit is connected to the power supply system, wherein the second energy storage unit comprises the plurality of lead acid batteries, and the power supply system supplies power to the lead acid batteries of the second energy storage unit.

7-8. (canceled)

9. The method according to claim 6, wherein when the lithium ion batteries of the first energy storage unit are fully charged, the lithium ion batteries are in an interrupted and standby state.

10. The energy storage method according to claim 6, further comprising:
performing supplementary charge for the lithium ion batteries of the first energy storage unit at regular intervals.

11. The method according to claim 6, wherein the lead acid batteries of the second energy storage unit are recycled lead acid batteries.
